(19) United States
(12) Patent Application Publication
(10) Pub. No.: US 2014/0183948 A1
(43) Pub. Date: Jul. 3, 2014

(54) METHOD AND CONTROLLER FOR CONTROLLING SUPPLY OF POWER FROM A BATTERY TO A LOAD

(71) Applicants: Michael Hulbert, Palm Beach (AU); Gregory Radion, Seaford (AU)

(72) Inventors: Michael Hulbert, Palm Beach (AU); Gregory Radion, Seaford (AU)

(73) Assignee: VOLT4 PTY LTD, Palm Beach (AU)

(21) Appl. No.: 14/240,974

(22) PCT Filed: Aug. 27, 2012
(86) PCT No.: PCT/AU2012/000996

§ 371 Date: Feb. 25, 2014

(30) Foreign Application Priority Data
Aug. 25, 2011 (AU) 2011903408

(51) Int. Cl. H02J 9/06; H02J 7/00

(52) U.S. Cl. CPC H02J 9/061; H02J 7/0052
USPC 307/23; 307/31

(57) ABSTRACT

A controller implemented method for controlling supply of power from a first battery to at least one load is provided. The controller is configured to interface with a database that includes permission data representing at least one respective associated time period for the, or each, load. The method includes reading the permission data from the database and permitting supply of power from the first battery to the, or each, load during the time period associated with that load.

### FIELD OF THE INVENTION

The invention relates to a method and controller for controlling supply of power from a battery to a load.

### BACKGROUND TO THE INVENTION

There is an ongoing need for the development and improvement of controllers for controlling the supply of power from a battery to one or more loads.

### SUMMARY OF THE INVENTION

The invention provides a controller implemented method for controlling supply of power from a first battery to at least one load, the controller being configured to interface with a database that includes permission data representing at least one respective associated time period for the, or each, load, the method including:
reading the permission data from the database, and
permitting supply of power from the first battery to the, or each, load during the time period associated with that load.

Reference to a “first battery” does not necessarily imply that the controller is configured for use with only more than one battery or that the method necessarily incorporates at least two batteries.

Furthermore, “battery” is to be understood as referring to a product or component that functions as a battery. For example, the word can be understood to mean a combination of two or more conventional batteries or cells connected together in series or in parallel to provide a single power supply.

The database may include permission data representing at least one respective associated battery capacity level for the, or each, load, in which case the method may include:
detecting a battery capacity level of the first battery; and
permitting supply of power from the first battery to the, or each, load when the battery capacity level is above the battery capacity level associated with that load.

The phrase “battery capacity level” is to be understood to include a level of charge remaining in a battery or a particular amount of work able to be carried out by the battery.

The method may include:
permitting supply of power from a second battery to the, or each, load;
detecting when the second battery is unable to supply power to the, or each, load; and
when detected, enabling the first battery to supply power to the, or each, load and controlling supply of power from the first battery to the, or each, load as defined above.

The method may include:
detecting when neither battery is able to supply power to the, or each, load; and
when detected, activating a standby battery for providing power to the controller for keeping the controller in operation for detecting when the either of the batteries is restored above the predefined thresholds.

The method may include enabling an external power source to charge the first and second batteries.

The method may include enabling the first battery to charge before enabling the second battery to charge.

The method may include receiving the permission data from an onboard user interface of the controller, and storing the permission data in the database.

The method may include receiving the permission data over a data communication network, and storing the permission data in the database.

The method may include generating message data relating to a status of any one of the batteries and loads, and sending the message data over a data communication network to a terminal device.

The method may include generating message data relating to enabling or disabling of any of a battery or a load, and sending the message data over a data communication network to a terminal device.

The invention also provides a controller implemented method for controlling supply of power from a main and a backup battery to a plurality of loads, the controller being configured to interface with a database that includes permission data representing respective associated time periods during which power is to be supplied to the loads and representing respective associated battery capacity levels for the loads, the method including:
reading the permission data from the database;
supplying power to the loads from the main battery;
detecting when the main battery is unable to supply power to the loads and enabling the backup battery in response to such detection;
detecting a battery capacity level of the backup battery; and
permitting supply of power from the backup battery to the loads during the time periods associated with the loads when the battery capacity levels are above the battery capacity levels associated with those loads.

The invention further provides a non-transitory processor-readable medium which includes processor-readable instructions, which, when executed by a processor of the controller, configures the controller to perform the method as herein defined, described, and illustrated.

The invention extends to a controller which is configured to perform a method as herein defined, described, and illustrated.

### DETAILED DESCRIPTION OF THE PREFERRED EMBODIMENT

A controller, in accordance with the invention, for controlling supply of power from a battery to a load may manifest itself in a variety of forms. It will be convenient hereinafter to describe embodiments of the invention in detail with reference to the accompanying drawings. The purpose of providing this detailed description is to instruct persons having an interest in the subject matter of the invention how to carry the invention into practical effect. However it is to be clearly understood that the specific nature of this detailed description does not supersede the generality of the preceding broad description.

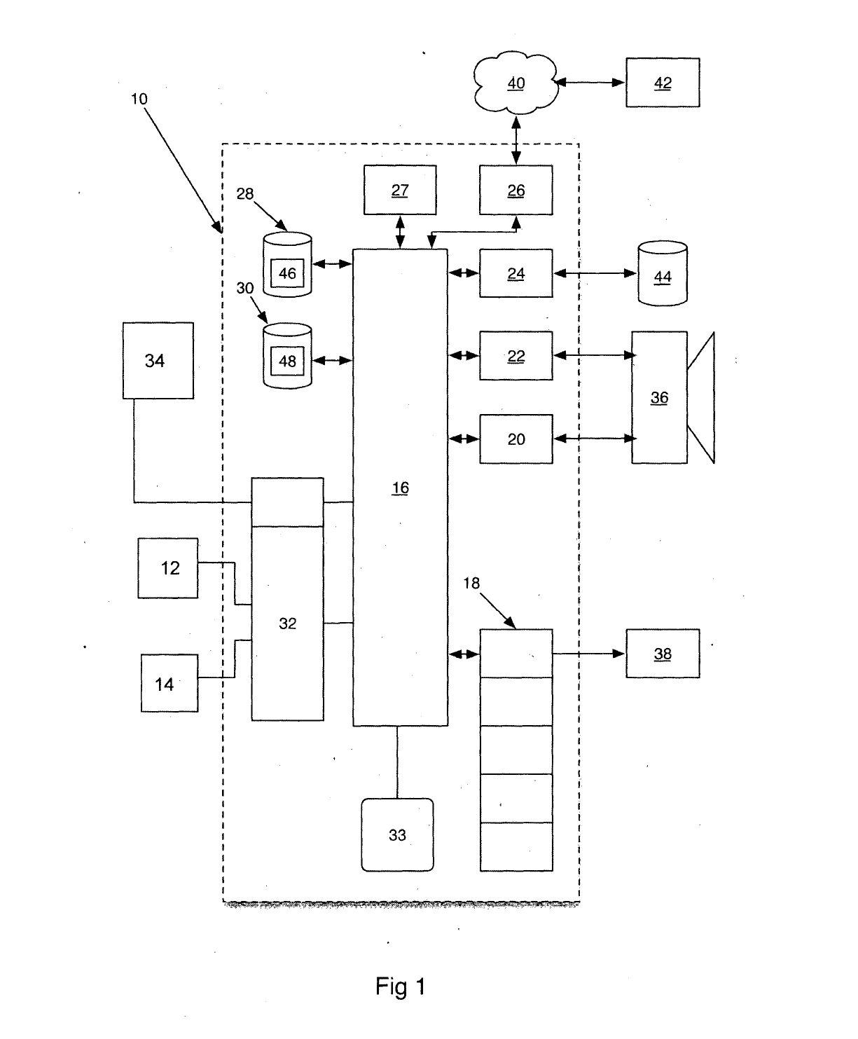

FIG. 1 shows a functional block diagram of a controller, in accordance with the invention, for controlling supply of power from a battery to at least one load.

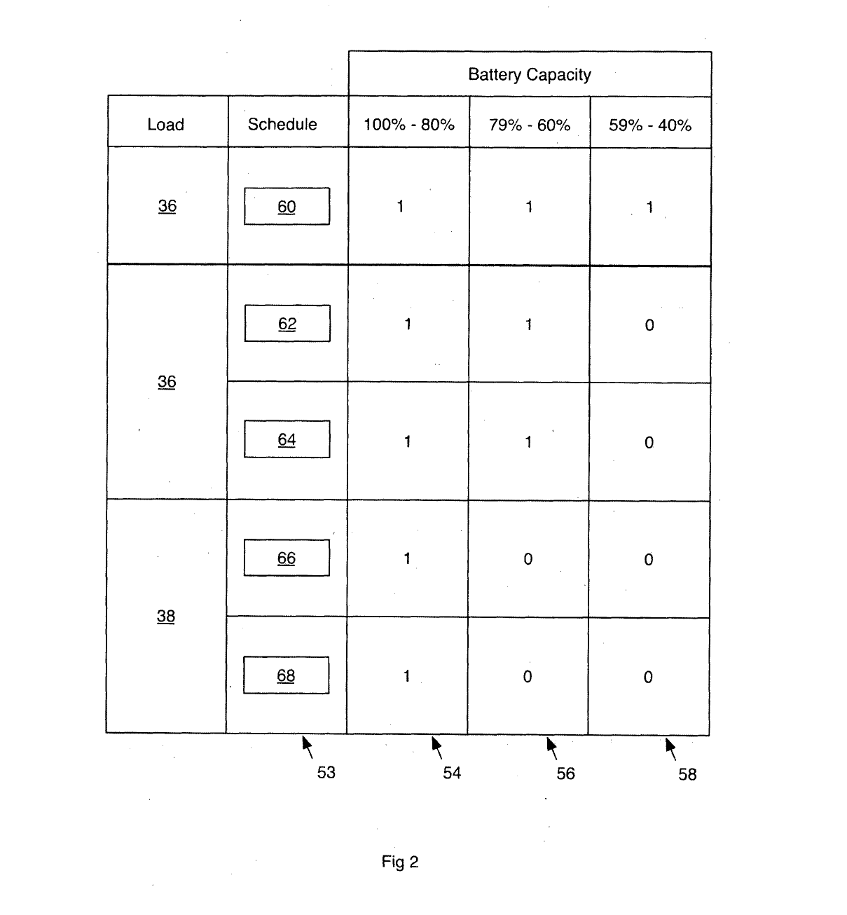

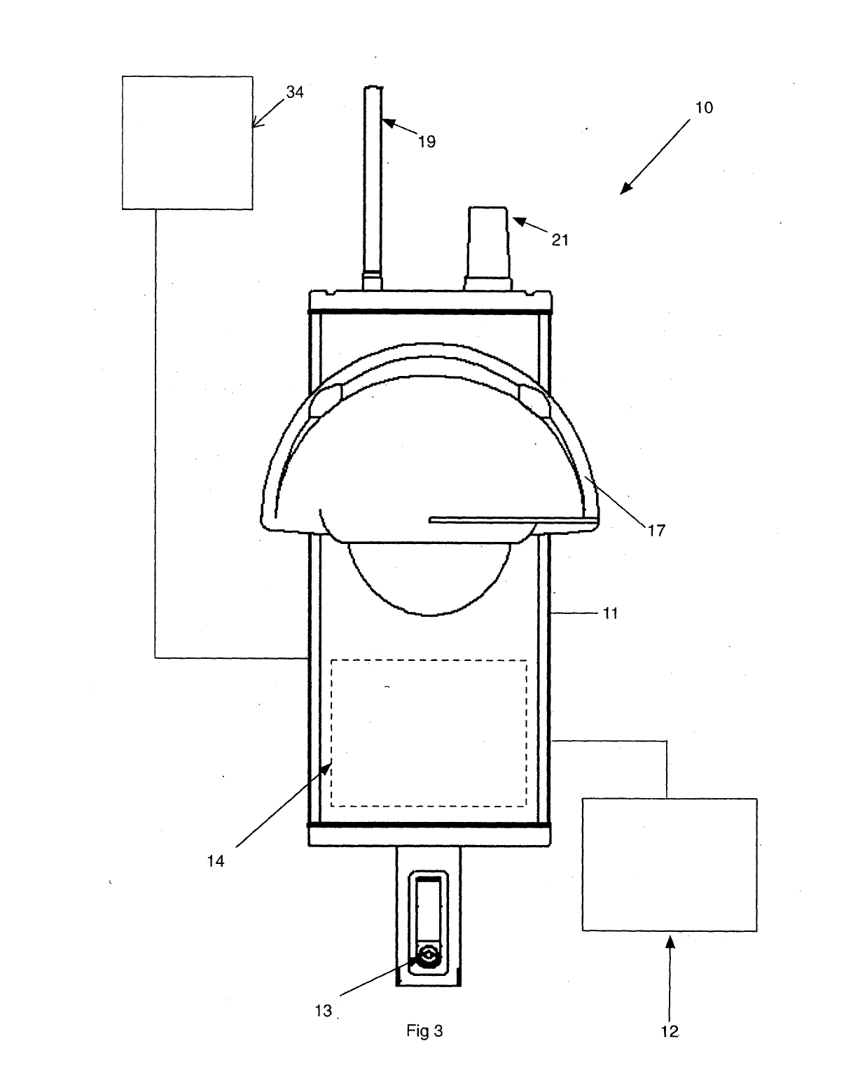

FIG. 2 shows a table illustrating permissions that are defined in relation to the at least one load, for use by the controller according to which the supply of power is permitted from the battery to the loads.

FIG. 3 shows a part schematic and part diagrammatic front view of a controller, in use.

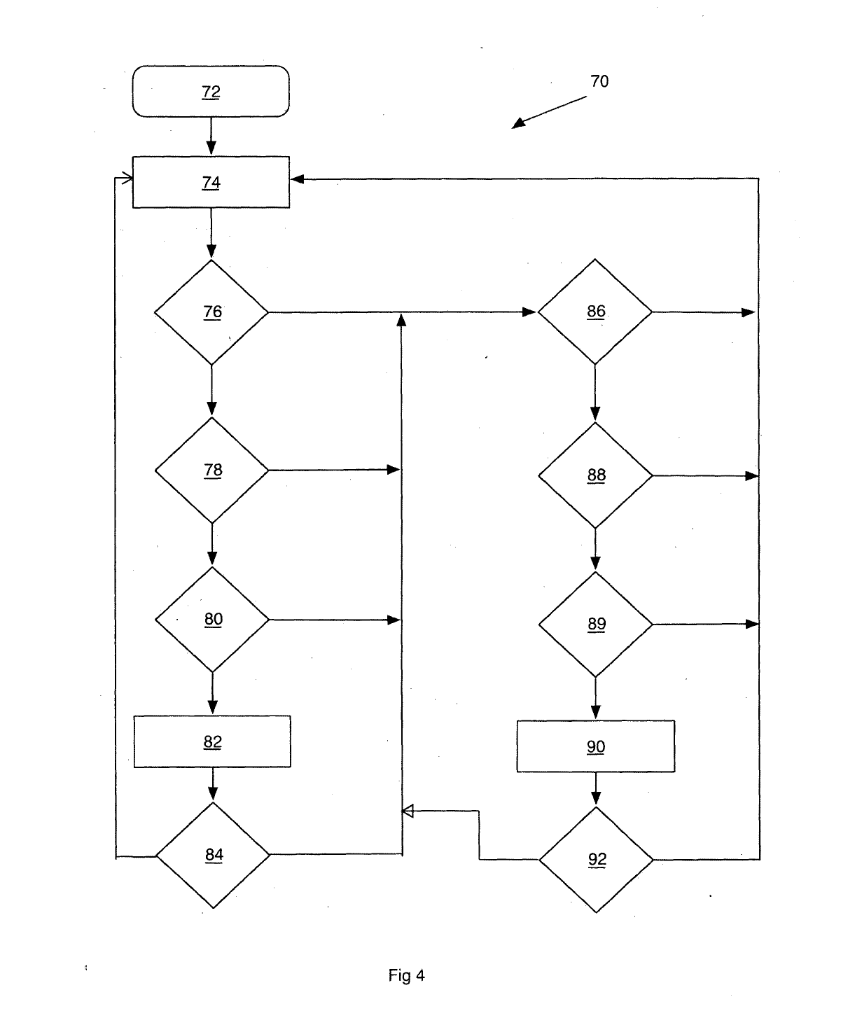

FIG. 4 shows a functional flow diagram of a controller thread forming part of a controller readable program.

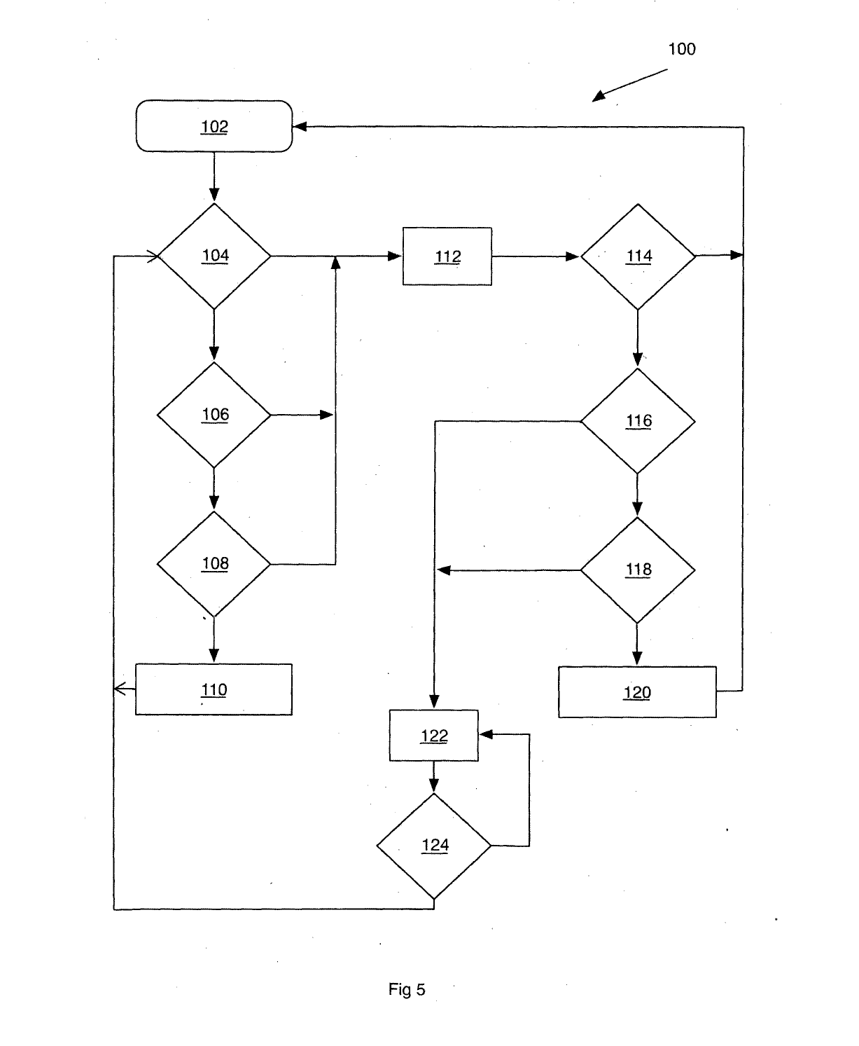

FIG. 5 shows a functional flow diagram for another controller thread.

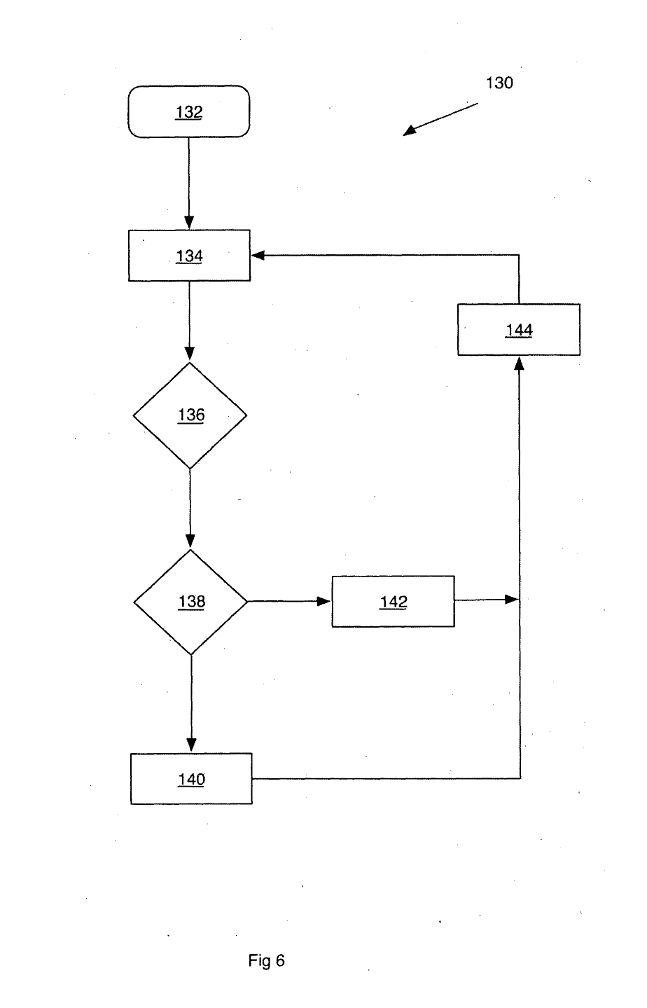

FIG. 6 shows a functional flow diagram of another controller thread.

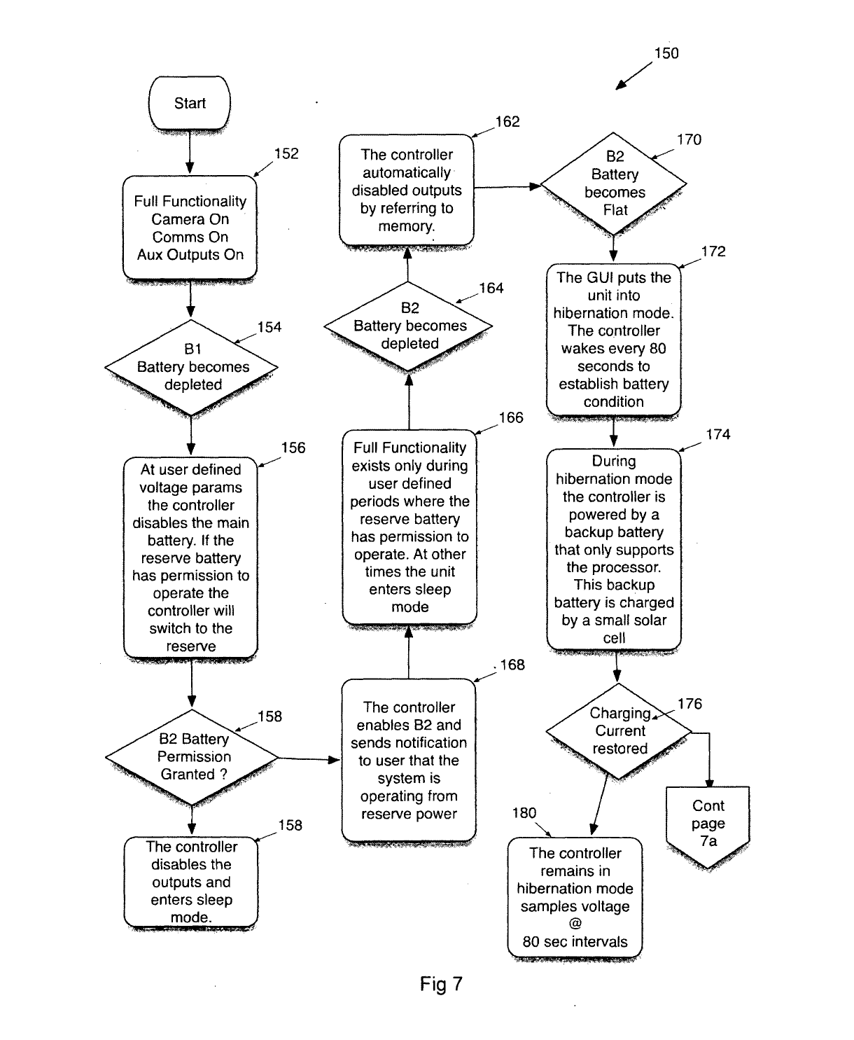

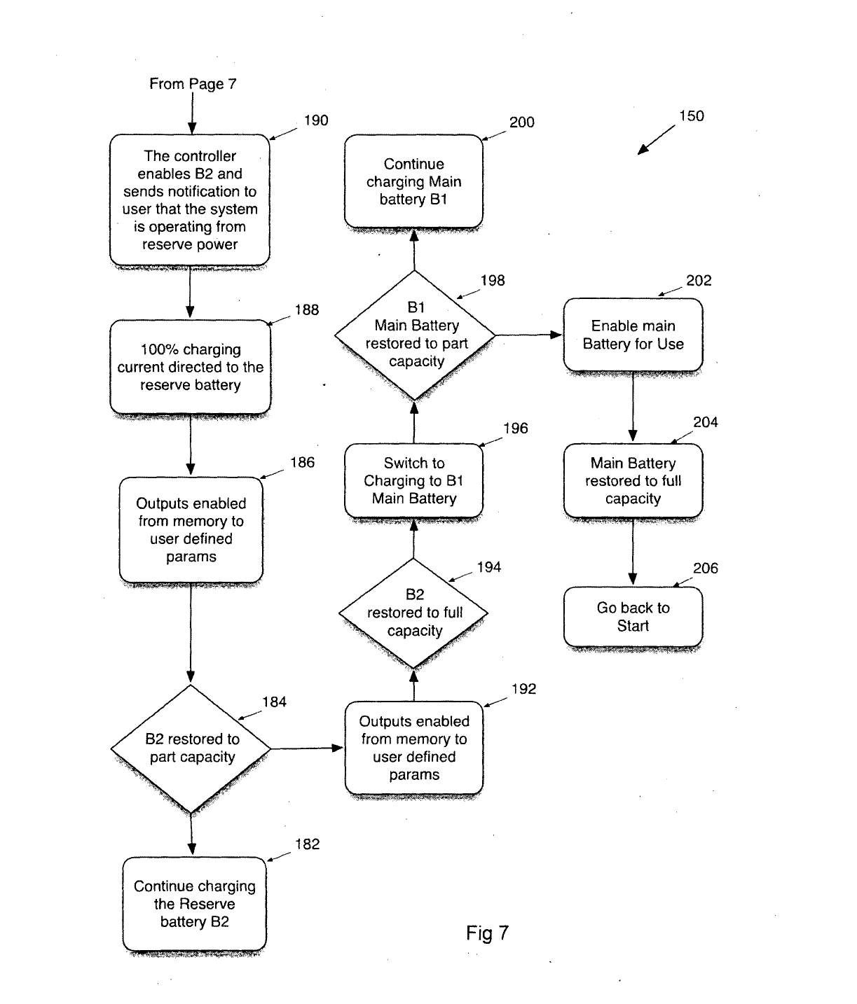

FIG. 7 shows a flow diagram of a methodology in which the controller is used for controlling supply of power from a mains battery and a backup battery to three loads.

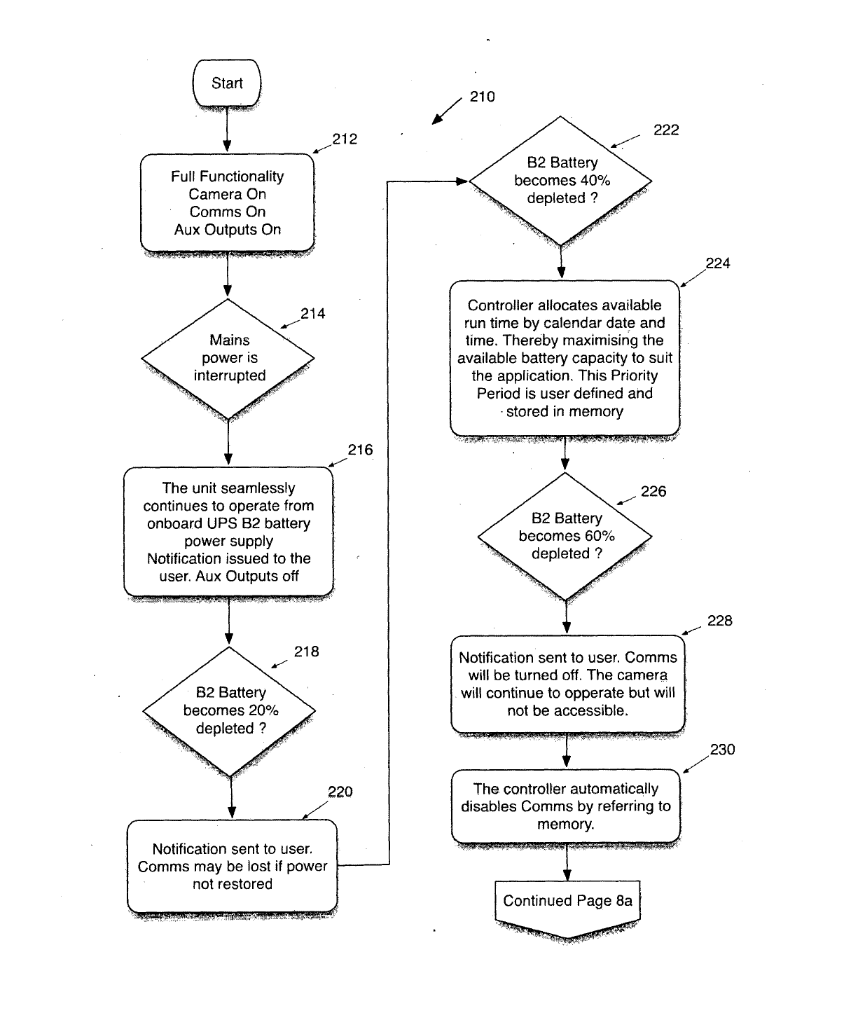

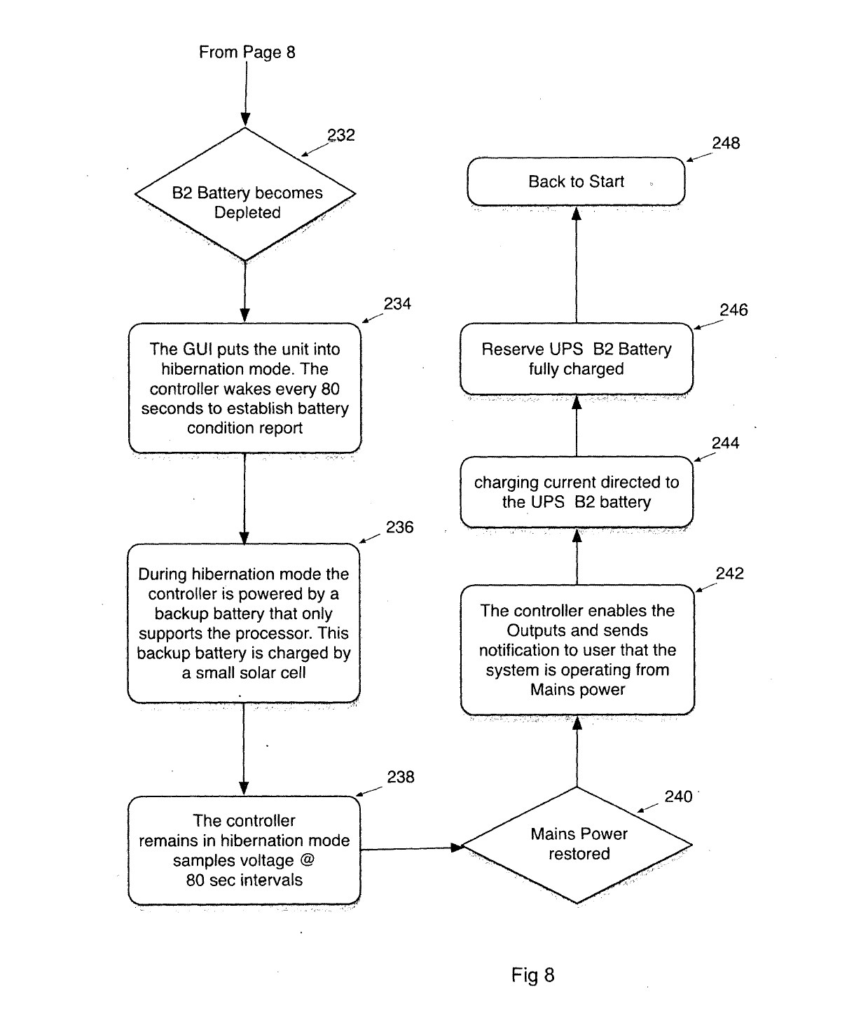

FIG. 8 shows a flow diagram of a methodology in which the controller is used for controlling supply of power from a mains power supply of an electrical distribution system and a backup battery to loads.

FIG. 9 shows a high-level block diagram of another embodiment of a controller.

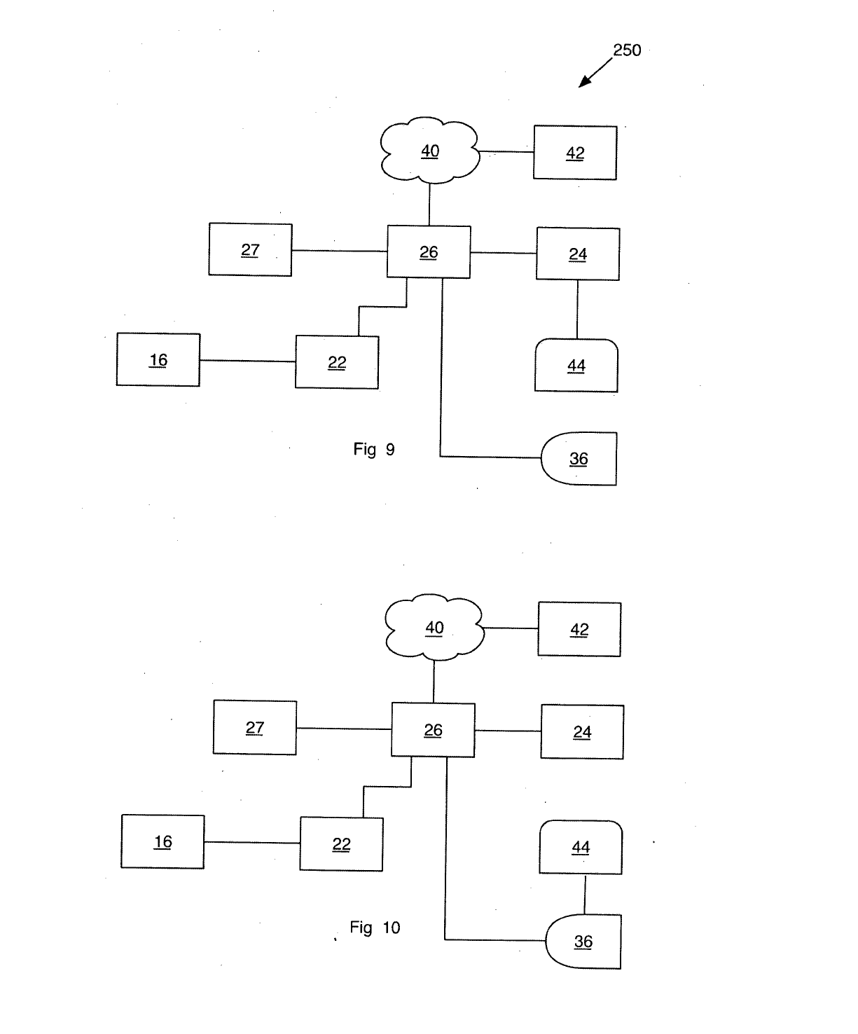

FIG. 10 shows a high-level diagram of still another embodiment of a controller.

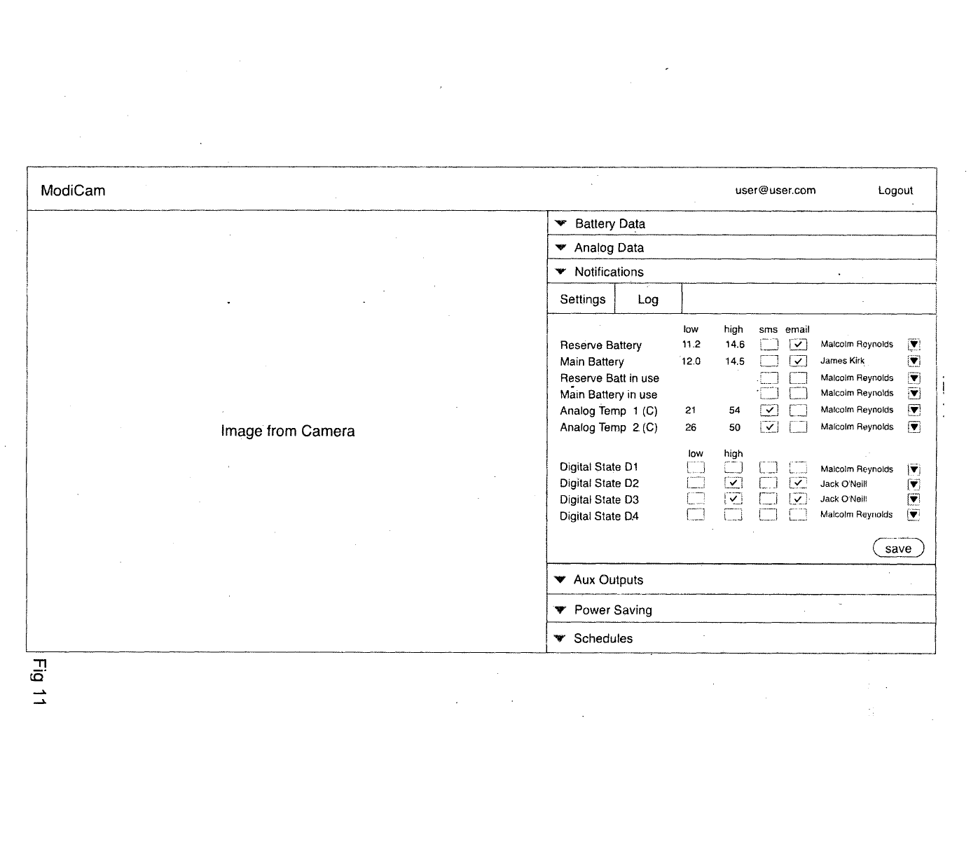

FIGS. 11 to 13 show embodiments of a graphical user interface (GUI) for a web browser for use in interfacing with the controller over a data communication network.

In the drawings, reference numeral 10 generally indicates a controller, in accordance with the invention, for controlling supply of power from two batteries 12, 14 to a number of loads as explained in more detail below.

Broadly, the controller 10 includes a processor in the form of a microprocessor 16, I/O ports 18, Power over Ethernet (PoE) module 20, two USB ports 22, 24, a communications module 26, a GPS module 27, a data memory or database 28, a program memory 30, a power supply interface module 32, and conventional peripheral components for enabling the controller 10.

One USB port may be a mini PCI port, a mini PCIe port, or any other port type suitable for interfacing a memory drive. In one embodiment, this USB port can form part of the communications module 26.

The two batteries 12, 14 are connected to the power supply interface module 32, and a photovoltaic module 34 (and/or wind power generating module) is connected to the power supply interface module 32. The power supply interface module 32 therefore incorporates a charge controller, battery management controller, and the like, to manage proper interfacing and operation between the photovoltaic module 34 and the batteries 12, 14.

In this example, and for purposes of explanation, the loads include two external loads, namely an IP camera 36 and an auxiliary load 38 (for example a light), and an internal load namely the communications module 26. The IP camera 36 is connected to the PoE module 20 for providing power over an Ethernet port to the IP camera 36 and is connected to one USB port 22. The auxiliary load 38 is connected to a 5 volt output terminal of the I/O module 18. It will be appreciated that the loads can be defined by any number of other components or products that are configured to consume battery power.

The communications module 26 includes communication interfaces for communicating with terminal devices 42 by way of any conventional protocol over data communication network, hard wired or wireless. Thus, the communications module 26 could be used for communication over the Internet, a LAN, a WAN, and the like. The communications module 26 can include replaceable radio transmitters for communication over a wide range of frequency, for example between 2.4 GHz and 5.8 GHz, directional or omnidirectional antennae, and the like. The terminal device 42 can be a personal computer, an Internet-enabled mobile communications device, such as a mobile telephone, tablet device, or the like.

An external data storage 44 is connected to another USB port 24, where the port 24 is integral to the module 26. The external data storage 44 may be a USB memory device powered by the cameral port. Alternatively, with a larger memory device the USB camera port provides data only and power is supplied from an Aux output of the controller. In this configuration the memory comes under the control of the controller and various parameters are available to the user. An example might be the USB storage device is only powered periodically and receives data dumps from the camera and is then disabled to minimize power consumption.

To this end, the controller 10, together with the camera 36, two batteries 12, 14 and PV module 34, form a standalone battery powered camera unit that can be used for example in a security camera application.

Broadly, in accordance with the method of the invention, the controller 10 controls the manner in which power is supplied from the batteries 12, 14 to the loads 26, 36, 38 and also controls the manner in which the batteries are charged by an external power source, such as the PV module 34. In particular, one battery 12 serves as a main battery which continuously supplies power to the loads 26, 36, 38, and the other battery 14 serves as a backup battery to supply power to the loads 26, 36, 38 when the main battery 12 is unavailable, for example, if the main battery has failed, or is depleted, or the like.

When power is to be supplied by the backup battery, the controller 10 controls the supply of power to the loads 26, 36, 38 in accordance with permissions or rules, which are explained in more detail below, that are preconfigured for the loads 26, 36, 38. When followed by the controller 10, the permissions or rules increase the time period over which the backup battery is depleted compared to a case in which the backup battery 14 was to supply power continuously to the loads 26, 36, 38 similar to the manner in which the main battery 12 supplies power.

The database 28 includes permission data 46 representing, for each load 26, 36, 38 respectively, associated time periods during which power is to be supplied to that load. In other words, the permission data 46 forms a scheduler having scheduled time periods for each load 26, 36, 38, respectively, that determine when that load is switched on, otherwise that load is switched off. In the case of a security camera 36, it may be that a user considers night time a higher risk than day time, and can schedule the camera to be switched on during night time only when the backup battery is enabled for supplying power to the loads.

In some cases, the loads can be scheduled, according to a user's preference, to be switched on during the same time periods. However, as the backup battery 14 depletes, it is useful to provide preference or priority to one load over another load. It follows that the permission data 46 represents a respective battery capacity level for each load, and the controller can detect the battery capacity level of the backup battery 14, permitting supply of power from the backup battery to a load only when the battery capacity level is above the battery capacity level associated with that load.

For illustration, FIG. 2 shows a table setting out permissions for supplying power from the backup battery 14 to the loads 26, 36, 38. In column 53, a time period 60 for the camera 36 is set. Similarly, time periods 62, 64 are set for the communications module 26, and time periods 66 and 68 are set for the auxiliary load 38. The time periods 60, 62, 64, 66 and 68 can include a date, start time and end time.

Columns 54, 56, and 58 correspond with battery capacity ranges 100%-80%, 80%-60%, and 60%-40% respectively. On/off flags are indicated by 1 or 0 entered in columns 54, 56, 58, in which a 1 indicates that it is permitted to supply power to a load within the battery capacity range for that column.

Thus, if time periods 60, 62, and 66 for the three loads overlap, then when the backup battery capacity is between 100% and 80% power is supplied to all three loads as per the schedule. If the battery capacity is between 80% and 60%, power is supplied only to the camera 36 and communications module 26, and if the battery capacity is between 60% and 40%, power is supplied only to the camera. This occurs even though the loads 26, 36, 38 have been scheduled to be switched at the same time according to the schedule. In other words, the flags in relation to the battery capacities override the scheduled permission as the backup battery 14 becomes depleted.

FIG. 3 shows a part schematic and part diagrammatic front view of a controller 10 that includes a housing 11. The housing 11 can be hermetically sealed or “weatherproof” for housing the controller components outdoors, and includes a mounting bracket 13 for mounting onto a support. The mounting bracket 13 can include a quick-release type connecter to facilitate quick release of the housing 11 from the support.

A mounting formation 17 in the form of an adaptor plate is provided on the housing 11 for cooperating with a complementary mounting formation of the IP camera. The PoE port 20 is located adjacent the adaptor plate 17.

Antennae 19, 21 of the communications module 26 protrude through a top side of the housing 11. Antennae 19 are of a simple design. The housing 11 facilitates the fitting of a number of different antenna types in order to provide a site specific Wifi network or directional two way bridge or node within an extended LAN. Similarly the 3G antenna may be replaced by a site specific directional design.

The reserve battery 14 is also housed inside the housing 11, and the main battery 12 is external to the housing 11 which facilities access and replacement.

FIG. 4 shows a functional flow diagram of one thread of the controller program for controlling the charging sequence of the batteries 12, 14. At 72, the thread executes. At 74, the availability of charging current from the PV module is detected. The controller checks, at 76, if the backup battery 14 is available for charging, and if it is, checks, at 78, if a permission is set to permit charging of the backup battery 14. At 80 the controller 10 determines if the backup battery 14 needs charging, and if it does, charges the backup battery 14, at 82. At 84, the controller 10 checks if the battery is fully charged, and if not, proceeds to 76.

If the permission is not set, at 78, or if the backup battery 14 does not need charging, at 80, or if the backup battery 14 is fully charged, at 84, then the controller 10 checks, at 86, if the main battery 12 is available. At 88, the controller checks if a permission is set that allows charging of the main battery 12, and if it is, checks, at 89, if the main battery 12 requires charging. If it does, the battery is charged, at 90. At 92, the controller 10 checks if the main battery 12 is fully charged, and if not, proceeds to 86.

If the permission is not set, at 88, or if the main battery 12 does not require charging, at 89, or if the main battery 12 is fully charged at 92, then the thread repeats.

It follows that the backup battery 14 is always charged before the main battery 12.

FIG. 5 shows another thread 100, for the controller 10 to enable one of the batteries 12, 14 for supplying power. The thread executes at 102. At 104, the controller 10 checks if the main battery 12 is available, and if it is, checks at 106 if a permission is set for the main battery 12 to be enabled, and if so, performs a heath check, at 108. The health check can include testing the battery's capacity level. If the main battery 12 is healthy, then the main battery 12 is enabled at 110 for supplying power to the loads as controlled by the controller 10.

If the main battery 12 is not available, at 104, or the permission is not set, at 106, or the main battery 12 is not healthy, at 108, then a notification is generated, at 112, by the controller 10 and sent to the terminal device 42 over the data communication network 40 to alert the user that the controller 10 is switching supply over to the backup battery 14.

At 114, the controller 10 checks if the backup battery 14 is available. The controller 10 checks at 116 if a permission is set for the backup battery 14 to be enabled if the backup battery 14 is available. If the backup battery is available, the controller 10 performs a heath check, at 118. If the backup battery 14 is healthy, then it is enabled, at 120, for supplying power to the loads as controlled by the controller 10.

If the permission for the backup battery 14 is not set, at 116, or the backup battery 14 is not healthy, at 118, then the controller 10 enters, at 122, a hibernation mode, and activates a timer, at 124. When the timer runs out, the thread proceeds to start, at 102, and repeats to check if any one of the batteries has become available.

FIG. 6 shows a functional flow diagram 130 of a thread for switching the loads on and off based on the preconfigured permission data 46 in the database 28. The thread is executed, at 132. At 134, the controller selects the relevant output (pin/port), and hence the load that is to receive power. At 136, the controller 10 checks if the scheduler includes an associated time period for that load which corresponds with the existing controller's system time, and if it does, then checks, at 138, if the backup battery 14 is at a capacity level that permits supply of power to that load. The controller supplies power to the load, at 140, if the backup battery is at the capacity level. The thread proceeds to 144, where the controller 10 selects the next output, and repeats the process for the next output to determine if power should be supplied to that output. If the controller determines, at 138, that the battery capacity is too low to allow the supply of power to that load, then a message is generated and sent, at 142, over the network to the terminal device.

It will be appreciated that steps for generating and sending messages (notifications, alerts, warnings) to a user's terminal device, which can be by way of email, SMS, or the like, could be incorporated at any point in the process. For example, notifications can be generated to alert a user that a load is about to be shutdown, or that the capacity of a battery is below a certain battery capacity level, or the battery power is restored, or the like.

The controller 10 includes a thread that enables a user to access and configure the controller 10. For example, the controller 10 can host a web service so that a GUI is accessible over the Internet for enabling configuration of permissions, downloading stored data from the controller 10, and the like. The GUI can also permit a user to override existing preconfigured permissions in the database, manually to turn loads on and off, view statuses of batteries and loads, and the like. Also, the GUI enables a user to select multiple recipients, and specify which messages are sent to which recipients.

The messages are in a user definable message format such as SMS, email or other notifications to clients' back end servers or any other device able to read data.

Each battery can include cells, for example a battery can include four Lithium Ion Phosphate cells to form a battery pack, and each battery pack can include an associated battery management module to control safe voltage and current limits for the battery. In one embodiment, the battery management module can be configured for monitoring each cell of the battery independently, and for controlling the charging current to the cells in such way as to mitigate excessive lead or lag of cell capacities relative to one another during the charging process. Also, monitoring the cells individually enables the controller 10 to generate a message for sending to a user when any one of the cells deteriorates.

The controller 10 also includes a standby power supply in the form of a PV module 33, which is relatively small in rating, and able to supply just enough power for keeping the controller active during hibernation mode so that the controller 10 can detect when the battery power or external supply power is restored.

FIG. 7 broadly shows a flow diagram 150 of a methodology in which the controller 10 is used with two batteries, one battery (B2) being the backup or reserve battery 14 and the other battery being a main battery 12 (B1).

Initially, at 152, power is supplied by the main battery 12 to the camera 36, communication module 26 and auxiliary load 38, which are switched on. At 154, the controller 10 detects that the main battery 12 is depleted, and disables the main battery 12, at 156. At 158, the controller 10 detects if the backup battery 14 has permission to supply power and if not, switches off all loads and enters, at 160, into hibernation or sleep mode. Otherwise, the controller enables the backup battery 14, at 168, and generates and sends a message to the terminal device 42.

At 166, the controller 10 controls the loads so that they are on as per the schedule for the loads. During other times, the controller 10 enters hibernation mode. At 164, the controller 10 detects that the backup battery capacity drops below a preconfigured threshold capacity, and in response disables, at 164, some of the loads as set in the battery capacity permissions for the loads in the database 28 even if the loads would otherwise have been on as per the schedule for the loads.

The controller detects, at 170, that the backup battery capacity has dropped below an operational threshold capacity, and enters into hibernation mode, at 172, and checks at preconfigured intervals if the backup battery 14 has been restored or charged to an operational capacity. At 174, during hibernation mode, the controller is powered by the standby battery which is charged by a small PV module 33.

At 176, the controller detects that the backup battery is charged and operational, and enables supply of power to the loads as per their permissions, and sends a message to the terminal device 42 that the loads are operating on backup power, otherwise the controller remains in hibernation mode, at 180.

The controller 10 detects, at 188, that the backup battery is being charged, and power to the loads is controlled, at 186, as per the loads' permissions. At 184, the controller 10 checks the capacity of the backup battery, and continues charging the backup battery, at 182, and continues to control supply of power to the load according to the permission of the load, at 192.

The controller 10 detects, at 194, that the backup battery capacity is fully restored, and in response, enables charging, at 196, of the main battery. At 198, the controller checks if the main battery is fully charged, and if not, continuous to charge the main battery, at 200, otherwise disables the backup battery and enables, at 202, supply of power from the main battery. The main battery is now restored at full capacity, at 204, and the process returns, 206, to the start of the process.

Relevant messages about status, actions, triggers, or the like, can be generated and sent to a user before, after or during any step in the process.

FIG. 8 broadly shows a flow diagram 150 of a methodology in which the controller 10 is used with a backup battery together with an external power supply, such as an electrical distribution system or powered data cable, or the like for supplying power during normal conditions to the loads.

At 212, power is supplied to the loads from the external power source, for example, from a mains electrical supply. At 214, the controller detects that the main supply is not available, and in response, enables, at 206, supply of power from the backup battery, generates and sends a message to the terminal device 42, and switches off the auxiliary loads.

At 218, the controller detects that the backup battery has depleted 20%, and generates and sends, at 220, a message to the terminal device to notify a user that the communication module will be shut down. At 222, the controller detects that the battery is 40% depleted, and the controller, at 224, continues controlling supply of power to the loads according to the permissions that are set for the loads. The controller detects, at 226, that the backup battery is 60% depleted, and in response generates and sends a message to the terminal device 42 that the communication module 26 is being shut down, and shuts down the communication module, at 230.

At 232, the controller detects that the backup battery has been depleted below operational battery capacity level, and the controller enters, at 234, into hibernation. During hibernation, the controller is powered by the standby battery and small PV module 33, and checks at regular intervals, at 238, if the mains power is restored. If the controller detects, at 240, that the mains power is restored, then the controller restores power to the loads, at 242, and sends a message to the terminal device that the loads are supplied with power from the mains power supply. At 244, the backup battery is charged, and at 246, the backup battery is fully charged, and the process returns to the start, at 248.

In these embodiments, history data, or data from the field instruments, such as the camera, can be stored in the controller 10, for later retrieval from a terminal device, or uploaded to an FTP server, or the like. For example, the controller 10 could store third party data on drive 44. Drive 44 can be a USB drive or other HD storage device. Drive 44 can be accessed via the GUI so that the data can be uploaded.

In one embodiment, the camera has a USB port which connects directly to a USB memory device powered by the camera port. Alternatively, the USB camera port can provides data only, and power is supplied from the controller to camera by an auxiliary output. In such a case, The USB port can be powered only periodically to receive data dumps from the camera and is then disabled to reduce power consumption from the battery.

In some applications, such as remote security camera applications, it is useful to use a battery pack for the backup battery, and for the main battery, that respectively includes four 3.3 Volt Lithium Ion Phospate (LiFEP04) cells, to form a 13.2 Volt battery pack. However, the controller 10 can be configured to use any one of a number of battery types. LiFEP04 cells have a long life cycle, compared to lead acid battery variants, can be deep cycled, and have the ability to retain capacity level for prolonged time when not in use.

Usefully, the controller 10 allows a user a high degree of battery management, so that a user can configure operating permissions for loads to extend a useful uptime of the loads during times when the loads rely on a backup battery.

The controller provides information, which can be send over a data communication network, to a user that enables a user remotely to manage the controller, and to alert a user about statuses, actions, triggers, and the like of the controller, loads, and batteries. Also, hibernation mode can be induced by the user via the GUI. Admin rights to the controller 10 are required to activate hibernation mode.

The controller 10 can be configured to use any conventional communication protocols for communication with the filed instruments, such as the camera, for example a ModBus protocol. This enables a number of controllers to be deployed in a LAN configuration, and to communicate with a central terminal, for example at a security control room. The GUI provides an interface whereby multiple cameras can be managed from a single interface. Schedules, settings and other parameters can be copied to multiple controllers of cameras. A single camera system can be configured as a master, and can control the functionality of slave cameras if so desired.

FIG. 9 shows an arrangement 250 incorporating the controller 10. The GPS 27, the USB port 24 with a data storage 44 connected thereto, and the camera 36 are interfaced with the processor 16 indirectly via the communications module 26. The camera 36 sends data to the communications module 26 where the data is directed to the data storage 44 which is effectively connected to the network 40. The data storage 44 can be a NAS, and be connected to a 5V power supply which can be controlled by the controller 10. For example the NAS can be powered periodically only to store data, and then switched off to reduce power consumption from the battery. The NAS storage device is a target from the camera's perspective. The camera formats the drive using a data storage software protocol designed to enhance data retrieval. Data can be downloaded via a Wifi LAN, 3G WAN, and the like.

FIG. 10 shows another arrangement 250 incorporating the controller 10, in which the data storage 44 in the form of a USB drive, is connected directly to the camera 36. The camera 36 sends data to the storage device 44 directly. This USB storage device 44 may receive power and data on the same cable. The USB storage device 44 can be located some distance from the camera 36 unit subject to the limitations of the USB power supply from the camera 36. However this may be augmented by supplying power from the controller 10 by way of the 5v Output, which can be controlled by the controller 10.

The USB storage device 44 is a target from the camera's perspective. The camera 36 applies a different set of protocols under this arrangement. The protocols are such that that they are designed to extend the life of a solid state drive like the USB data storage 44. Data can be downloaded from the USB data storage 44 by way of a Wifi LAN or by physically removing the USB data storage 44.

In particular, in security camera applications, in which power and communications are provided to cameras over hardwire data cables, the controller 10 provides a useful backup for both power and communication in the case that the power supply and communications over the data cable fails. Messages can be sent via wireless LAN or 3G WAN because the hardwired network would mostly be lost at the same time as the Power being provided by the Ethernet cable conforming to PoE protocol.

The mounting bracket 13 is designed to include two parts. The one part is attached to the housing 11, and the other part to the support structure. The one part can be left on the support, when the housing is removed, so that over time a network of camera sites can be established by the mounting bracket parts left on their supports, which facilitates ease of redeployment.

FIG. 11 shows a GUI generated by the controller 10, or by a peripheral device connected to the controller 10, that can be used by an operator to determine capacities or charges remaining in the batteries. The GUI of FIG. 11 also shows the names of varies parties using a system that incorporates the controller 10. The GUI allows selection of which parties can be emailed or sent an SMS for various characteristics of the batteries.

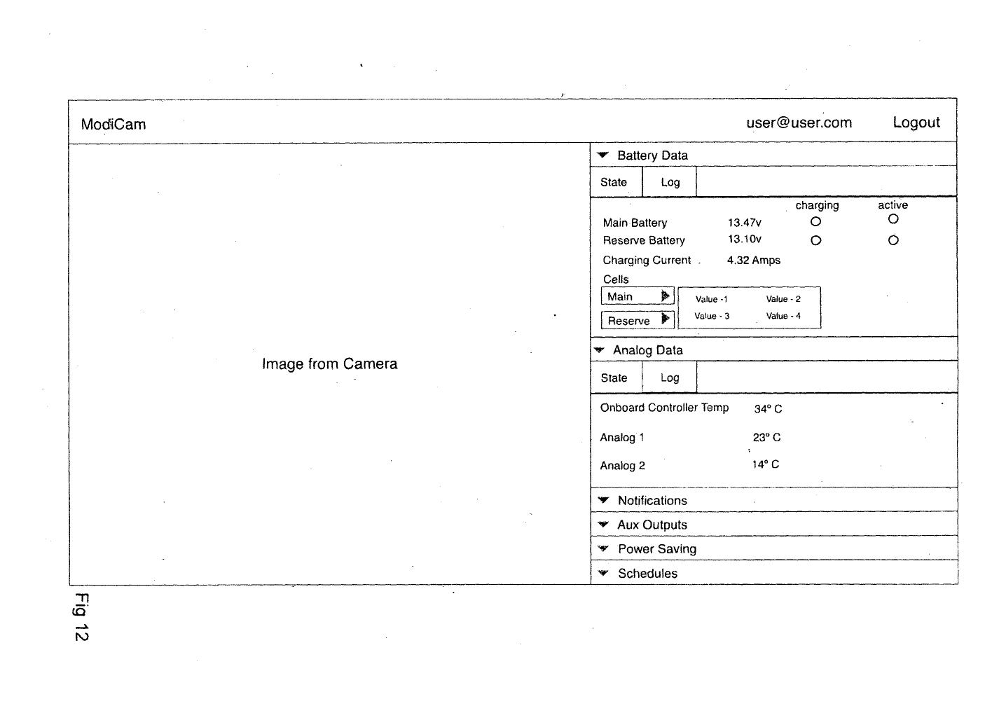

FIG. 12 shows a GUI generated by the controller 10, or by a peripheral device connected to the controller 10, that can be used by an operator to determine a charge state of the main and back-up or reserve batteries.

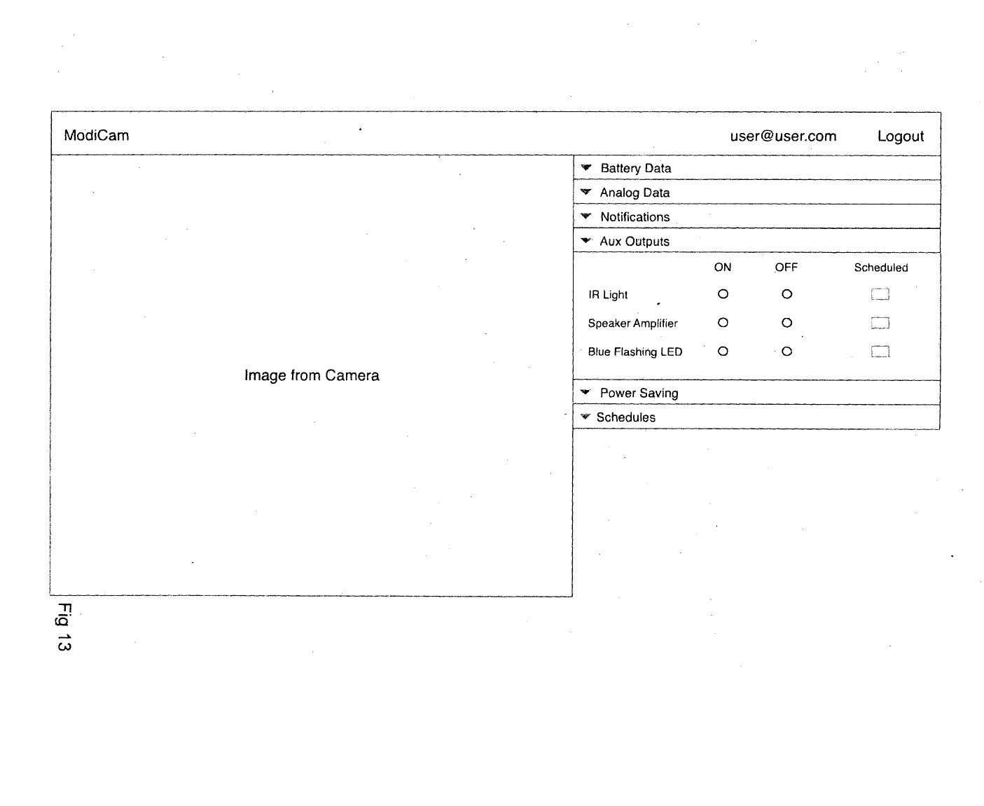

FIG. 13 shows a GUI generated by the controller 10, or by a peripheral device connected to the controller 10, that can be used by an operator to determine the condition of various auxiliary outputs of the controller 10.

It will be appreciated that each of the GUI's can be generated remotely from the controller 10.

It is to be understood that the terminology employed above is for the purpose of description and should not be regarded as limiting. The described embodiments are intended to be illustrative of the invention, without limiting the scope thereof. The invention is capable of being practiced with various modifications and additions as will readily occur to those skilled in the art.

Throughout the specification, including the claims, where the context permits, the term “comprising” and variants thereof such as “comprise” or “comprises” are to be interpreted as including the stated integer or integers without necessarily excluding any other integers.

Various substantially and specifically practical and useful exemplary embodiments of the claimed subject matter are described herein, textually and/or graphically, including the best mode, if any, known to the inventors for carrying out the subject matter defined in the summary portion. Variations (e.g., modifications and/or enhancements) of one or more embodiments described herein might become apparent to those of ordinary skill in the art upon reading this application. The inventors expect skilled artisans to employ such variations as appropriate, and the inventors intend for the subject matter to be practiced other than as specifically described herein. Accordingly, as permitted by law, the subject matter includes and covers all equivalents of the subject matter and all improvements to the subject matter. Moreover, every combination of the above described elements, activities, and all possible variations thereof are encompassed by the subject matter unless otherwise clearly indicated herein, clearly and specifically disclaimed, or otherwise clearly contradicted by context.

The use of any and all examples, or exemplary language (e.g., “such as”) provided herein, is intended merely to better illuminate one or more embodiments and does not pose a limitation on the scope of any subject matter unless otherwise stated. No language in the specification should be construed as indicating any non-defined subject matter as essential to the practice of the subject matter defined in the summary.

Thus, regardless of the content of any portion (e.g., title, field, background, summary, description, abstract, drawing figure, etc.) of this application, unless clearly specified to the contrary, such as via explicit definition, assertion, or argument, or clearly contradicted by context, with respect to any claim, whether of this application and/or any claim of any application claiming priority hereto, and whether originally presented or otherwise:
a. there is no requirement for the inclusion of any particular described or illustrated characteristic, function, activity, or element, any particular sequence of activities, or any particular interrelationship of elements;
b. no characteristic, function, activity, or element is “essential”;
c. any elements can be integrated, segregated, and/or duplicated;
d. any activity can be repeated, any activity can be performed by multiple entities, and/or any activity can be performed in multiple jurisdictions; and
e. any activity or element can be specifically excluded, the sequence of activities can vary, and/or the interrelationship of elements can vary.

The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Moreover, when any number or range is described herein, unless clearly stated otherwise, that number or range is approximate. Recitation of ranges of values herein are merely intended to serve as a shorthand method of referring individually to each separate value falling within the range, unless otherwise indicated herein, and each separate value and each separate subrange defined by such separate values is incorporated into the specification as if it were individually recited herein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

1. A controller implemented method for controlling supply of power from a first battery to at least one load, the controller being configured to interface with a database that includes permission data representing at least one respective associated time period for the, or each, load, the method including:
reading the permission data from the database, and
permitting supply of power from the first battery to the, or each, load during the time period associated with that load.

2. A method as claimed in claim 1, in which the database includes permission data representing at least one respective associated battery capacity level for the, or each, load, the method including:
detecting a battery capacity level of the first battery; and
permitting supply of power from the first battery to the, or each, load when the battery capacity level is above the battery capacity level associated with that load.

3. A method as claimed in claim 2, which includes:
permitting supply of power from a second battery to the, or each, load;
detecting when the second battery is unable to supply power to the, or each, load; and
when detected, enabling the first battery to supply power to the, or each, load and controlling supply of power from the first battery to the, or each, load as claimed in claim 1 or 2.

4. A method as claimed in claim 3, which includes:
detecting when neither battery is able to supply power to the, or each, load; and
when detected, activating a standby battery for providing power to the controller for keeping the controller in operation for detecting when the either of the batteries is restored above the predefined thresholds.

5. A method as claimed in claim 4, which includes enabling an external power source to charge the first and second batteries.

6. A method as claimed in claim 5, which includes enabling the first battery to charge before enabling the second battery to charge.

7. A method as claimed in claim 6, which includes receiving the permission data from an onboard user interface of the controller, and storing the permission data in the database.

8. A method as claimed in claim 6, which includes receiving the permission data over a data communication network, and storing the permission data in the database.

9. A method as claimed in claim 8, which includes generating message data relating to a status of any one of the batteries and loads, and sending the message data over a data communication network to a terminal device.

10. A method as claimed in claim 8, which includes generating message data relating to enabling or disabling of any of a battery or a load, and sending the message data over a data communication network to a terminal device.

11. A controller implemented method for controlling supply of power from a main and a backup battery to a plurality of loads, the controller being configured to interface with a database that includes permission data representing respective associated time periods during which power is to be supplied to the loads and representing respective associated battery capacity levels for the loads, the method including:
reading the permission data from the database;
supplying power to the loads from the main battery;
detecting when the main battery is unable to supply power to the loads and enabling the backup battery in response to such detection;
detecting a battery capacity level of the backup battery;
permitting supply of power from the backup battery to the loads during the time periods associated with the loads when the battery capacity levels are above the battery capacity levels associated with those loads.

12. A non-transitory processor-readable medium which includes processor-readable instructions, which, when executed by a processor of the controller, configures the controller to perform the method as claimed in claim 1 or 11.

13. A controller which is configured to perform a method as claimed in claim 1 or 11.
